(19) United States
(12) Patent Application Publication
(10) Pub. No.: US 2011/0120050 A1
(43) Pub. Date: May 26, 2011

(54) Building Insulation Compound with Separating Components to Prevent Compression

(76) Inventor: Thomas Atwood, Franklin, WI (US)

(21) Appl. No.: 12/907,447

(22) Filed: Oct. 19, 2010

Related U.S. Application Data
(60) Provisional application No. 61/263,227, filed on Nov. 20, 2009.

(51) Int. Cl. E04C 2/284; C08L 25/06; C08L 1/00; B65G 53/36; B01F 13/00

(52) U.S. Cl. 52/794.1; 524/577; 524/35; 523/122; 406/120; 366/343

(57) ABSTRACT

The present invention is an attic insulating material comprised of polystyrene separating components mixed with cellulose fibers, which has a stabilized R-factor compared to cellulose insulation. The addition of polystyrene to the cellulose prevents settling of the insulation and the resulting diminished R-factor.

### CROSS-REFERENCE TO RELATED APPLICATIONS

This application claims priority to U.S. Provisional Application No. 61/263,227 filed on Nov. 20, 2009.

### FIELD OF INVENTION

The present invention relates to the field of materials used for insulating buildings, and more specifically to a building insulation compound which has an extended life and lower propensity for mold growth.

### BRIEF DESCRIPTION OF THE DRAWINGS

FIG. 1 illustrates an exemplary method of making and using a building insulation compound with an extended life.

FIG. 2 illustrates an exemplary embodiment of a building insulation compound with an extended life as it would be used in a building.

### GLOSSARY

As used herein, the term “additive” refers to any chemical known in the art that may be added to blown insulation.

As used herein, the term “air trapping fiber” refers to any material capable of trapping a quantity of air. Air trapping fibers may include, but are not limited to, cellulose, organic material, refuse, fabric, fiberglass, sand, plastics, inorganic materials or combinations of these materials.

As used herein, the term “base R-factor” refers to the R-factor of insulation at the time of installation.

As used herein, the term “current R-factor” refers to the R-factor of insulation at the time R-factor is being measured. The current R-factor for insulation may be less than the base R-factor.

As used herein, the term “heat flow per unit area” or “heat flux” refers to the flow of energy through insulation per unit area per unit time.

As used herein, the term “non-settling” refers to the property of a blown building insulation to resist compression and decreasing in volume after installation.

As used herein, the term “R-factor” or “R-value” refers to the measure of thermal resistance used in the building and construction industry. Under uniform conditions, R-value is the ratio of the temperature difference across an insulator (ΔT) and the heat flux, or heat flow per unit area, through it (\dot{Q}_{A}) and is represented by the equation R=ΔT/\dot{Q}_{A}. R-factors are usually represented in units of ft²hr° F./Btu in.

As used herein, the term “R-factor time ratio” means the current R-factor divided by the base R-factor and is used to indicate the amount of change in R-factor over a given time. A greater R-factor time ratio indicates less change in R-factor.

As used herein, the term “separating component” refers to any material or structure adapted to preserve the airspace trapped by air trapping fibers including but not limited to cellulose, polystyrene, organic material, refuse, fabric, fiberglass, sand, plastics, inorganic materials or combinations of these materials.

As used herein, the term “stabilized R-factor” refers to the R-factor that insulation will maintain after settling.

As used herein, the term “structure” refers to any partially or fully enclosed space with at least one exterior surface adapted to receive insulation.

As used herein, the term “temperature deference” refers to the change in temperature observed across an insulator.

As used herein, the term “weighted polystyrene” refers to polystyrene adapted to be installed by blowing. Weighted polystyrene may include polystyrene modified by the addition of static charge, adhesive, a weight component or combinations thereof.

### BACKGROUND

The efficiency of insulation used in buildings is measured by a calculation known in the art as a thermal resistance, or R-factor.

The R-factor varies for each type of insulation. As the amount of air space between the insulation particles increases, the R-factor increases. The larger the R-factor, the more effective the insulation. Some types of insulation will settle over time, which decreases the R-factor and the effectiveness of the insulation.

Air is the best insulator, and insulation materials known in the art are adapted to trap a quantity of air pockets within the material to increase the R-factor of the insulation.

Fiberglass batts and blankets are one type of commonly used insulation for unfinished walls. However, fiberglass batts and blankets are expensive, have a low R-factor and are difficult to install. Care must be taken to ensure that there are no cracks in between the sheets which may reduce the effectiveness of the insulation.

Polyurethane insulation materials are also available. Polyurethane insulation is available as spray foam or as rigid foam board. Spray foam is installed using a blower making it suitable for both enclosed existing walls and new walls. It expands when installed, blocking airflow and leaks, and it works well in tight spaces. However, the cost of spray foam is high compared to traditional insulation, and the R-factor diminishes over time. Rigid foam boards are less susceptible to a diminishing R-factor; however, they are more expensive than spray and harder to install.

Cellulose may also be used as loose-fill insulation. Cellulose insulation is made from recycled wood fiber, primarily newsprint, making it environmentally friendly. Wood fiber is shredded and pulverized into small fibrous particles that pack tightly into closed building cavities, inhibiting airflow. Like other loose-fill insulations and spray foams, cellulose is blown through holes in enclosed existing walls or into new walls. Cellulose insulation has an average R-factor range of approximately 3.2 to 3.8 per inch depending on the manufacturer.

Manufacturers of cellulose insulation add chemicals to the cellulose to make it insect and fire resistant. A major disadvantage of cellulose, however, is that it absorbs more water than fiberglass insulation, which can become a problem if water leaks in from the outdoors. The water can also wash away the fire retardant. In addition, if not installed properly, cellulose insulation is prone to mold growth if it comes in contact with moisture.

Another downside to cellulose insulation is that it settles over time, requiring that the insulation be refilled. Settling diminishes the air space between individual cellulose particles, decreasing the R-factor and the effectiveness of the insulation. As loose-fill cellulose insulation settles, it looses about 20% of its volume over time, causing the R-factor to decrease as well. To account for settling, customers must pay for 20% more cellulose insulation than they initially thought to achieve the same R-factor.

Polystyrene is another material that is commonly used as loose-fill insulation. Loose-fill polystyrene insulation consists of small beads of polystyrene. The small beads are extremely lightweight, take a static charge very easily and are difficult to control.

Polystyrene can also be made into two types of foam board insulation: expanded and extruded polystyrene. Expanded polystyrene has a lower density and is less expensive than extruded polystyrene; however, it is also less effective as an insulator. Extruded polystyrene insulation has finer cells or beads and contains a mixture of air and refrigerant gas, making it a better insulator. The materials for polystyrene insulation are often quite expensive.

It is desirable to have an insulation which does not settle resulting in diminished air space and a lower R-factor.

It is further desirable to provide a use for used polystyrene.

It is further desirable to have a cost effective insulation.

It is further desirable to have an insulation that reduces the potential of mold growth.

It is further desirable to have an insulation that is easily transported.

It is further desirable to have an insulation that is fire resistant.

### SUMMARY OF THE INVENTION

The present invention is an building insulation compound with a greater R-factor time ratio and reduced cost. The building insulation compound contains a predetermined quantity of segregated fire retardant treated cellulose fiber and a predetermined quantity of segregated randomly shaped polystyrene separating components which are then mixed to ensure a consistent blend within a ratio by weight.

### DETAILED DESCRIPTION OF INVENTION

For the purpose of promoting an understanding of the present invention, references are made in the text to exemplary embodiments of an improved insulation material and process with extended R-factor life, only some of which are described herein. It should be understood that no limitations on the scope of the invention are intended by describing these exemplary embodiments. One of ordinary skill in the art will readily appreciate that alternate but functionally equivalent materials and processes may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

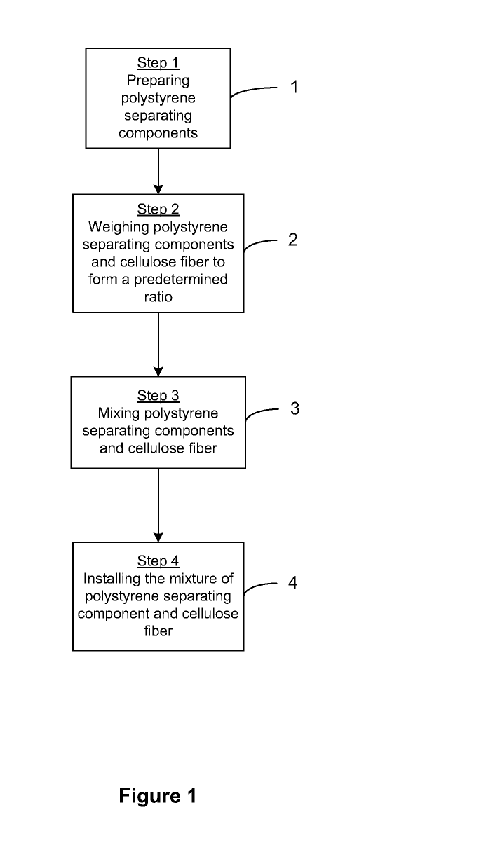

FIG. 1 illustrates an exemplary embodiment of a method of making and using an improved insulation material with a stabilized base R-factor.

In Step 1, polystyrene separating components are prepared by shredding or grinding polystyrene into small pieces. Because polystyrene is not uniformily shred or ground, the resulting separating components are irregularly shaped. The irregular shape also helps the polystyrene separating components keep cellulose fibers from settling.

In an exemplary embodiment, the resulting polystyrene separating components should be no larger than ¾ inch. Because of the different densities of polystyrene, the grinder must have a motor with a high horsepower. The grinder also has a plurality of blades that are welded onto a shaft. The blades may be of any size; however, they must reach nearly to the edge of the grinder in order to grind the polystyrene into the appropriate size pieces.

The polystyrene separating components are then packaged in order to be transported to a construction or building site or left as is if the grinding is done onsite.

Ideally, an arrangement will be made with landfills to set aside used polystyrene materials so that they can be collected. Polystyrene takes up a lot of space in landfills and is not biodegradable. Using polystyrene as insulation will keep the polystyrene out of landfills. When used polystyrene is collected, FIG. 1 may include the additional step of cleaning, disinfecting or sanitizing used polystyrene.

In Step 2, the prepared polystyrene separating components and cellulose fiber are weighed to reach a predetermined ratio by weight. Cellulose fiber insulation is known in the art (e.g., GreenFiber Blow in Natural Fiber Insulation), and may be used with the polystyrene separating components.

In an exemplary embodiment, the ratio-by-weight of polystyrene separating components to cellulose fiber is 50:50. In other embodiments, building insulation compound may contain up to 80% cellulose by weight mixed with polystyrene separating components.

In Step 3, the polystyrene separating components and cellulose fibers are mixed. The polystyrene separating components and cellulose fibers may be added to a mixer from a single reservoir after weighing, or added to a mixer from two separate reservoirs.

The combination of polystyrene separating components and cellulose fibers results in a loose-fill insulation that preserves the air space between the particles and prevents the mixture from settling. This preserves and stabilizes the R-factor of the installation, giving the polystyrene separating component/cellulose fiber insulation mixture a greater R-factor time ratio, and prevents having to add additional insulation later on.

In addition to the insulation benefits, the addition of polystyrene reduces the cost of the installation because polystyrene can be obtained very inexpensively. For example, the cost of the installation will be reduced by approximately 50% if a 50:50 mixture of polystyrene and cellulose is used.

The addition of polystyrene also reduces the potential for mold growth and increases the fire retardant properties of the insulation when compared to cellulose alone without adding extra weight to the insulation.

In further embodiments, Step 3 may also include adding additives, such as fire retardants or mold, insect or rodent resistant compounds.

In Step 4, the mixture of polystyrene separating components and cellulose fibers is installed using a blower. The number of inches blown determines the overall R-factor for the insulation. For example, a 40:60 blend of polystyrene separating components and cellulose fibers has an R-factor per inch of approximately 3.478 ft²hr° F./Btu in. Four inches of the 40:60 blend gives an overall R-factor of 13.9 ft²hr° F./Btu.

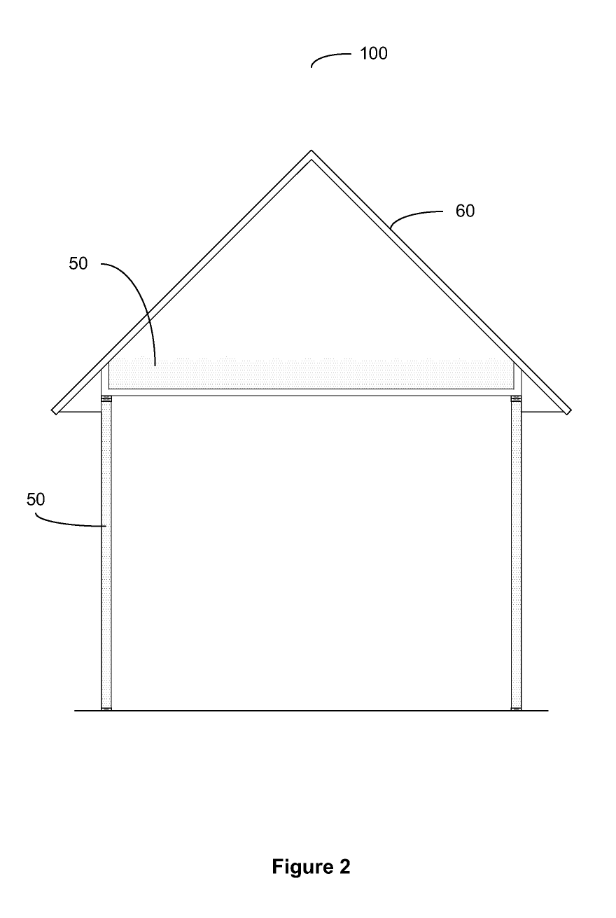

FIG. 2 illustrates an exemplary system using a building insulation compound with an increased R-factor time ratio 100. Building insulation compound 50 is installed between walls and in the attic of structure 60 to increase the thermal efficiency of structure 60.

What is claimed is:

1. A building insulation compound comprised of:
a first predetermined quantity of segregated fire retardant air trapping fibers; and
a second predetermined quantity of segregated separating components to prevent compression;
wherein said first predetermined quantity of segregated fire retardant air trapping fibers and said second predetermined quantity of segregated separating components are mixed to ensure the consistency of said first predetermined quantity and said second predetermined quantity in a predetermined ratio by weight to accomplish a designated R-factor.

2. The building insulation compound of claim 1 wherein said fire retardant air trapping fibers are cellulose fibers.

3. The building insulation compound of claim 1 wherein said a trapping fibers are weighted polystyrene.

4. The building insulation compound of claim 1 wherein said separating components are weighted polystyrene.

5. The building insulation compound of claim 1 wherein said separating components are bead shaped.

6. The building insulation compound of claim 1 wherein said air trapping fibers are bead shaped.

7. The building insulation compound of claim 1 wherein said air trapping fibers and said separating components are irregularly shaped.

8. The building insulation compound of claim 1 which further includes a predetermined quantity of fiberglass insulation.

9. The building insulation compound of claim 1 which further includes a third predetermined quantity of chemical treatment selected from the group consisting of fire retardant, mold resistant compounds, antimicrobial agents, moisture resist compounds, insect deterring compounds and rodent deterring compounds.

10. The building insulation compound of claim 1 wherein said first predetermined quantity of segregated fire retardant air trapping fibers is stored in a first bag and said second predetermined quantity of separating components is stored in a second bag for mixing on site.

11. The building insulation compound of claim 1 wherein said air trapping fiber is recycled paper.

12. The building insulation compound of claim 1 wherein said ratio of said first predetermined quantity of segregated fire retardant treated cellulose fiber and said second predetermined quantity of randomly shaped polystyrene separating components is between 80:20 and 10:90 by weight.

13. The building insulation compound of claim 1 wherein said ratio of said first predetermined quantity of segregated fire retardant treated cellulose fiber and said second predetermined quantity of randomly shaped polystyrene separating components is 60:40 by weight.

14. System for producing an a building insulation compound comprised of:
a reservoir of separating components;
a reservoir of air trapping fiber; and
a mixing component.

15. The system of claim 14 wherein said mixing component is selected from the group consisting of a paddle, a blender, a rotor, and a turning cylinder.

16. The system of claim 14 which further includes a hose.

17. The system of claim 14 which further includes a blowing component with a motor adapted to push said polystyrene separating components and said cellulose fiber out of said reservoirs.

18. The system of claim 14 wherein said reservoir of polystyrene and said reservoir of cellulose fiber are a single reservoir.

19. The system of claim 14 which further includes an additive reservoir.

20. An improved insulated building insulation system comprised of at least two contiguous structural surfaces having a channel space more than 3 inches, wherein space is filled with a compound comprised of blown polystyrene and cellulose fibers.
